(19) United States
(12) Patent Application Publication
(10) Pub. No.: US 2012/0087258 A1
(43) Pub. Date: Apr. 12, 2012

(54) USER TERMINAL AND METHOD FOR MANAGING DATA RELATED TO MINIMIZATION OF DRIVE-TESTS (MDT)

(75) Inventors: Hyeon LEE, Seoul (KR); Wang Chun KIM, Seoul (KR); Hyun Joon JEON, Guri-si (KR); Jae Sam JUNG, Seongnam-si (KR); Yong Jun CHO, Seoul (KR); Hyun Soo CHO, Seoul (KR)

(73) Assignee: PANTECH CO., LTD., Seoul (KR)

(21) Appl. No.: 13/227,072

(22) Filed: Sep. 7, 2011

(30) Foreign Application Priority Data
Oct. 12, 2010 (KR) 10-2010-0099154

(51) Int. Cl. H04W 24/00

(52) U.S. Cl. 370/252

(57) ABSTRACT

A user terminal and a method for managing data related to minimization of drive-tests (MDT) in the user terminal. The method includes entering into an MDT mode, receiving a system parameter from a base station, obtaining MDT-related data D_{N} measured at a current time T_{N}, and updating at least one of an average of the periodically measured MDT-related data ‘D_{Average}’ and information about distribution of the periodically measured MDT-related data ‘D_{Distribution}’ to reflect D_{N} based on the system parameter. The user terminal includes a measuring unit to measure D_{N}, a memory unit to maintain at least one of ‘D_{Average}’ and ‘D_{Distribution}’, based on a system parameter received from a base station; and a control unit to update at least one of the ‘D_{Average}’ and the ‘D_{Distribution}’ based on D_{N} measured at a current time T_{N}.

### CROSS-REFERENCE TO RELATED APPLICATION

This application claims priority from and the benefit under 35 U.S.C. §119(a) of Korean Patent Application No. 10-2010-0099154, filed on Oct. 12, 2010, which is incorporated by reference for all purposes as if fully set forth herein.

### BACKGROUND OF THE INVENTION

1. Field

Exemplary embodiments of the present invention relate to implementation of minimization of drive-tests (MDT), and more particularly, to a method for managing MDT-related data in a user terminal and a user terminal for performing the method.

2. Discussion of the Background

According to the radio communication standards, a user terminal may be used to store ‘raw logged data’ obtained for minimization of drive-tests (MDT) for a reference time. That is, ‘raw logged data’ obtained for MDT may be stored in a user terminal until the ‘raw logged data’ is reported to a network management system without reporting each measurement. Accordingly, a user terminal to support MDT may be equipped with a memory for storing measured ‘raw logged data’.

Because MDT-related data is periodically obtained, a memory capacity used for a user terminal may increase in proportion to time.

FIG. 1 is a view illustrating conventional data architecture to store data related to minimization of drive-tests (MDT).

Referring to FIG. 1, the conventional data architecture for storing MDT-related data may store periodically measured MDT-related data in a corresponding memory. If a user terminal moves between ‘Cell 1’, ‘Cell 2’, and ‘Cell 3’, the user terminal may separately maintain data 110 obtained in the ‘Cell 1’, data 120 obtained in the ‘Cell 2’, and data 130 obtained in the ‘Cell 3’ in a memory. The data 110 may maintain parameters in the memory, such as parameters of the following Table 1.

TABLE 1

| Parameters | Size | |
|---|---|---|
| Location information (Latitude/Longitude/ | 63 | bits |
| Altitude) | | |
| Time information (Month/Day/hour/Minute/ | 40 | bits |
| Second) | | |
| CGI (Cell Global Identity) of the serving | 52 | bits |
| cell (PLMN-id + Cell-id) | | |
| PCI (Physical Cell Identifier) of neighbour | 288 | bits |
| cells (×32) | | |
| Radio environment measurement (RSRP/RSRQ) | 429 | bits |
| for serving cell + neighbour cells (×32) | | |
| Total number of bits per log | 872 | bits |
| Total size of logs collected every 2 seconds for | Around 4.7 | Mbytes |
| 24 hours | | |

Referring to Table 1, data includes location information of the user terminal. That is, MDT-related data includes location information of a user terminal labeled as ‘location information’. Here, the ‘location information’ is latitude, longitude, and altitude of the measured location.

Also, the MDT-related data includes reference signal received power (RSRP) of a serving cell or a neighbor cell. This may refer to the magnitude of the electric field at a reference point spaced apart from a transmitting antenna.

### SUMMARY

Exemplary embodiments of the present invention provide a user terminal which may process and store data related to minimization of drive-tests (MDT) based on a communication environment or a reference condition.

Exemplary embodiments of the present invention also provide a method for determining a MDT mode based on a communication environment or a condition set by a network system.

Additional features of the invention will be set forth in the description which follows, and in part will be apparent from the description, or may be learned by practice of the invention.

Exemplary embodiments of the present invention provide a method for managing MDT-related data in a user terminal including entering into a MDT mode, receiving a system parameter from a base station, obtaining MDT-related data D_{N} measured at a current time T_{N}, and updating at least one of an average of the periodically measured MDT-related data ‘D_{Average}’ and information about distribution of the periodically measured MDT-related data ‘D_{Distribution}’ to reflect the MDT-related data D_{N} based on the system parameter.

Exemplary embodiments of the present invention provide a method for managing MDT-related data in a user terminal including entering into a MDT mode, receiving a system parameter comprising a flag from a base station, selecting at least one of a first procedure for storing periodically measured MDT-related data and a second procedure for processing and storing the periodically measured MDT-related data, based on a flag of a system parameter received from a base station; and performing at least one of the first procedure and the second procedure.

Exemplary embodiments of the present invention provide a method for managing MDT-related data in a user terminal including entering into a MDT mode, determining whether disconnection of communication with a serving cell occurred, and stopping measuring of a received field strength of the user terminal and measuring location information of the user terminal among the MDT-related data if disconnection of communication with a serving cell occurred.

Exemplary embodiments of the present invention provide a user terminal including a measuring unit to measure data related to minimization of drive-tests (MDT) in a MDT mode; a memory unit to maintain at least one of an average of the periodically measured MDT-related data ‘D_{Average}’ and information about distribution of the periodically measured MDT-related data ‘D_{Distribution}’, based on a system parameter received from a base station; and a control unit to update at least one of the ‘D_{Average}’ and the ‘D_{Distribution}’ based on MDT-related data D_{N} measured at a current time T_{N}.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a view illustrating conventional data architecture to store data related to minimization of drive-tests (MDT).

FIG. 2 is a view illustrating a data architecture to store MDT-related data according to an exemplary embodiment of the invention.

FIG. 3 is a block diagram illustrating a structure of a user terminal according to an exemplary embodiment of the invention.

FIG. 4 is a view illustrating a configuration of a Mth memory area of FIG. 3 according to an exemplary embodiment of the invention.

FIG. 5 is a flowchart illustrating a method for managing MDT-related data in a user terminal according to an exemplary embodiment of the invention.

FIG. 6 is a flowchart illustrating a method for managing MDT-related data in a user terminal according to an exemplary embodiment of the invention.

FIG. 7 is a flowchart illustrating a method for managing MDT-related data in a user terminal according to an exemplary embodiment of the invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. It will be understood that when an element is referred to as being “on” or “connected to” or “coupled to” another element, it can be directly on, directly connected to, or directly coupled to the other element, or intervening elements may be present. Further, it will be understood that for the purposes of this disclosure, “at least one of each” will be interpreted to mean any combination the enumerated elements following the respective language, including combination of multiples of the enumerated elements. For example, “at least one of X, Y, and Z” will be construed to mean X only, Y only, Z only, or any combination of two or more items X, Y, and Z (e.g. XYZ, XZ, YZ, X). Throughout the drawings and the detailed description, unless otherwise described, the same drawing reference numerals are understood to refer to the same elements, features, and structures. The relative size and depiction of these elements may be exaggerated for clarity, illustration, and convenience.

A user terminal may obtain MDT-related data in a MDT mode. A cycle for measuring the MDT-related data may be for a specified duration, such as 2 seconds. The MDT-related data may be data for measuring a propagation environment around the user terminal.

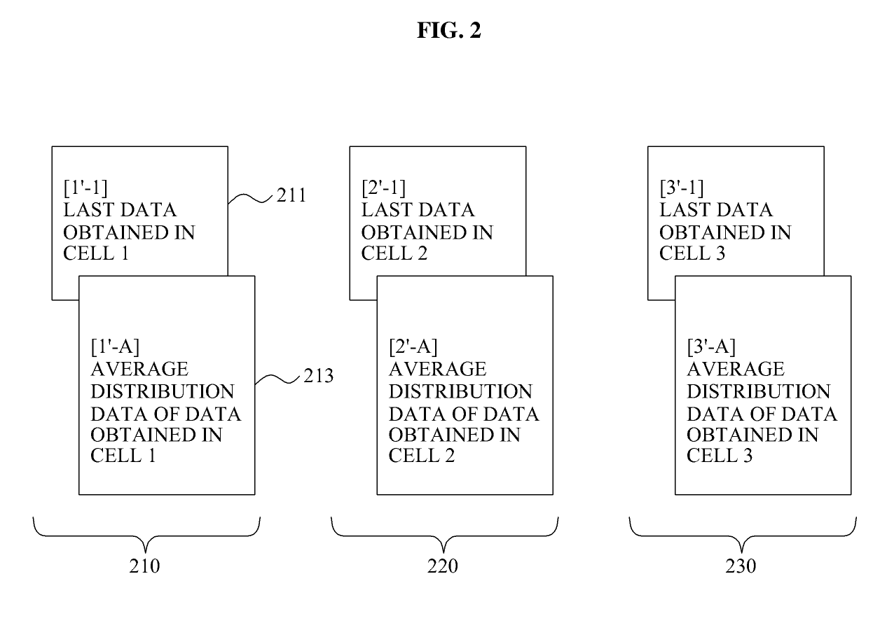

FIG. 2 is a view illustrating a memory configuration to store MDT-related data according to an exemplary embodiment of the invention.

In an example, the memory configuration to store MDT-related data may process and store MDT-related data based on a location of a user terminal, and store information on whether disconnection of communication with a serving cell has occurred at the location of the user terminal.

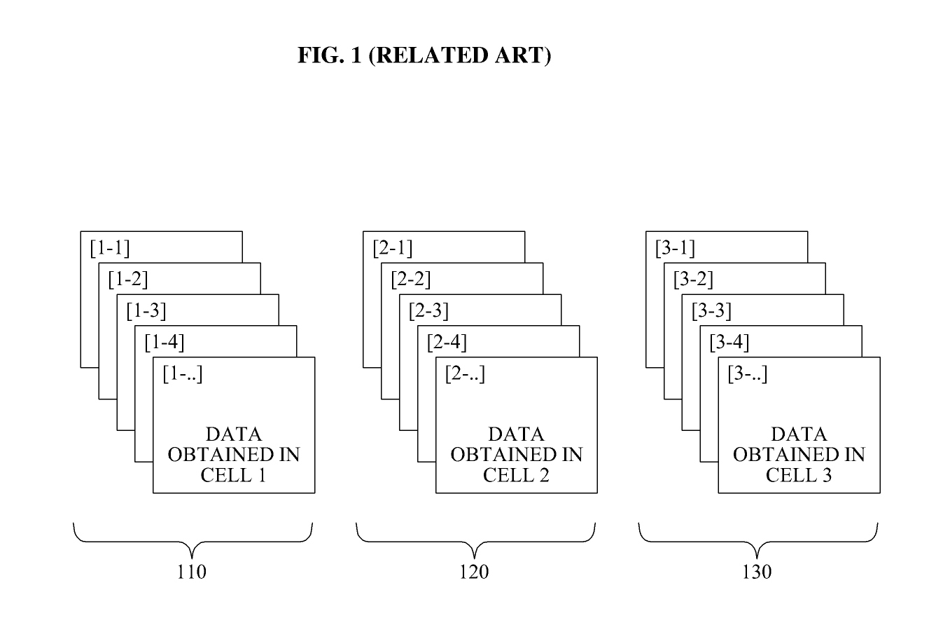

Referring to FIG. 2, a first memory area 210 is where MDT-related data obtained in ‘Cell 1’ is stored in a processed form. The first memory area 210 may include an area 211 where ‘last data’ or the data obtained most recently in the ‘Cell 1’ is maintained, and an area 213 where ‘average distribution data’ of MDT-related data obtained is maintained. In this instance, the ‘average distribution data’ may include an average of periodically measured MDT-related data. Also, the ‘average distribution data’ may include information about distribution of periodically measured MDT-related data. That is, the ‘average distribution data’ may denote an average and a degree of distribution of raw data measured in a MDT mode, rather than raw data measured in the MDT mode as illustrated in FIG. 1. Accordingly, the information about distribution of MDT-related data may include at least one of a maximum, a minimum, a variation, a standard deviation, and the number of periodically measured MDT-related data. In this instance, a measurement cycle of the MDT-related data may be, for example, 2 seconds, however, is not limited thereto.

Referring to FIG. 2, a second memory area 220 is where MDT-related data obtained in ‘Cell 2’ is stored as a processed data. In an example, the processed data may be the averaged distribution data, including the average and the degree of distribution of the raw data measured while the user terminal was in the MDT mode. Accordingly, if the user terminal is moves from the ‘Cell 1’ to the ‘Cell 2’ and remains in the ‘Cell 2’ for a reference time, the second memory area 220 may be maintained in the same configuration or the same data as the first memory area 210. Referring to FIG. 2, a third memory area 230 may be where MDT-related data obtained in ‘Cell 3’ is stored as a processed data.

As described below, in an example, the memory configuration of FIG. 2 may be maintained if the user terminal stays in the same location or within a reference range. Also, the memory configuration of FIG. 2 may be maintained if the user terminal is in a shadow area or a non-service area. Also, the memory configuration of FIG. 2 may be maintained based on a system parameter received from a base station.

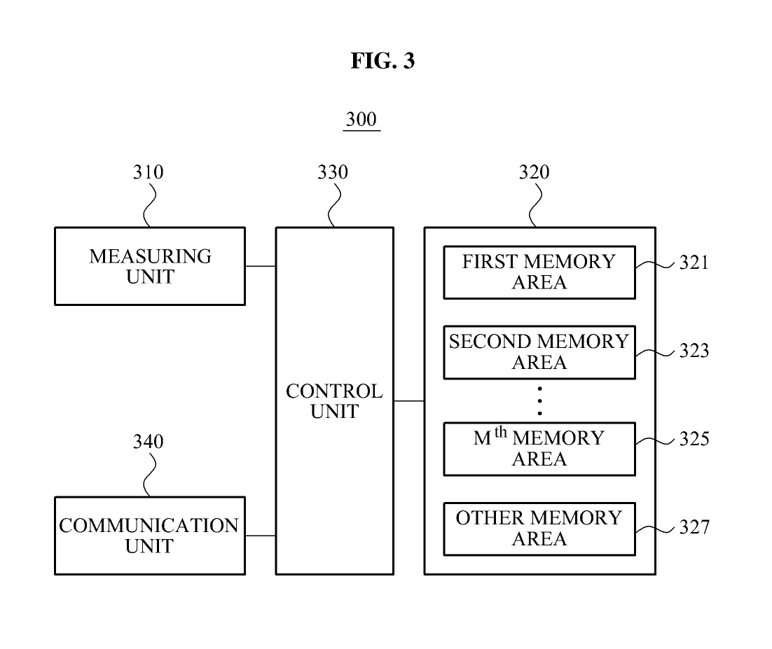

FIG. 3 is a block diagram illustrating a structure of a user terminal 300 according to an exemplary embodiment of the invention.

Referring to FIG. 3, the user terminal 300 may include a measuring unit 310, a memory unit 320, and a control unit 330. Also, the user terminal 300 may further include a communication unit 340.

If a user terminal 300 is set in a MDT mode, the measuring unit 310 may measure MDT-related data. That is, the measuring unit 310 may measure location information of the user terminal 300 or a received field strength of the user terminal 300. Here, the received field strength of the user terminal 300 may be a field strength of a reference signal received from a serving cell or a neighbor cell.

The memory unit 320 may store an average of periodically measured MDT-related data ‘DAverage’ based on a system parameter received from a base station. Also, the memory unit 320 may maintain information about distribution of periodically measured MDT-related data ‘DDistribution’. If the user terminal 300 moves to a plurality of cells while in the MDT mode, the memory unit 320 may separately maintain ‘DAverage’ and ‘DDistribution’ for each cell. That is, the memory unit 320 may include a first memory area 321 for storing MDT-related data obtained in ‘Cell 1’ and a second memory area 323 for storing MDT-related data obtained in ‘Cell 2’. Here, MDT-related data stored in the first memory area 321 may be raw data measured in the MDT mode or processed data in the first memory area 210 of FIG. 2. Also, the memory unit 320 may include an Mth memory area 325 for storing MDT-related data obtained in ‘Cell M’. Referring to FIG. 3, other memory area 327 may store a system parameter received from a base station or data generated in the user terminal 300.

The control unit 330 may update at least one of ‘DAverage’ and ‘DDistribution’ based on MDT-related data DN measured at a current time TN. The MDT-related data DN measured at the current time TN may be obtained from the measuring unit 310.

The control unit 330 may control the MDT mode to perform a specific procedure based on a system parameter received from a base station. In this instance, the MDT mode may perform a first procedure to store periodically measured MDT-related data, or a second procedure to maintain at least one of an average of periodically measured MDT-related data ‘DAverage’ and information about distribution of periodically measured MDT-related data ‘DDistribution’. Here, the system parameter may include at least one of information about a measurement cycle of MDT-related data, information about a storage architecture of MDT-related data, information about a type of MDT-related data, a reporting time of MDT-related data, and information about the MDT mode. The system parameter may be set by a network operator. The standard for setting the system parameter will be described below.

Also, the control unit 330 may control the MDT mode based on a flag of a system parameter received from a base station and a determination of whether disconnection of communication with a serving cell has occurred. The flag of the system parameter may be set by a network operator. The standard for setting the flag of the system parameter will be described below.

If the user terminal 300 moves to a plurality of cells during the MDT mode, the control unit 330 may separately store ‘DAverage’ and ‘DDistribution’ for each cell in the memory unit 320.

In an example, the control unit 330 may check the system parameter and a flag value of the system parameter, and may control the MDT mode to perform a specific procedure or be terminated. As described below, the system parameter and the flag value included in the system parameter may be changed by a base station. If a new system parameter is received during the MDT mode, the user terminal 300 may update the MDT mode to reflect the new system parameter. For example, a new ‘DAverage’ or ‘DDistribution’ may be calculated based on the new system parameter. Likewise, if a flag value of the system parameter received from a base station is changed, the user terminal 300 may change the MDT mode based on the changed flag value. For example, the MDT mode may perform the first procedure, the second procedure, or terminate the MDT mode based on the flag value of the new system parameter. Thus, by using the above disclosed configuration the MDT mode may be determined based on a communication environment or a condition set by a system, thereby efficiently measuring a propagation environment of a network.

The control unit 330 may include at least one processor.

In an example, the communication unit 340 may communicate wirelessly with a base station. Alternatively the communication unit 340 may communicate through a wire with a base station. The communication unit 340 may receive a system parameter from a base station, and may transmit MDT-related data to the base station.

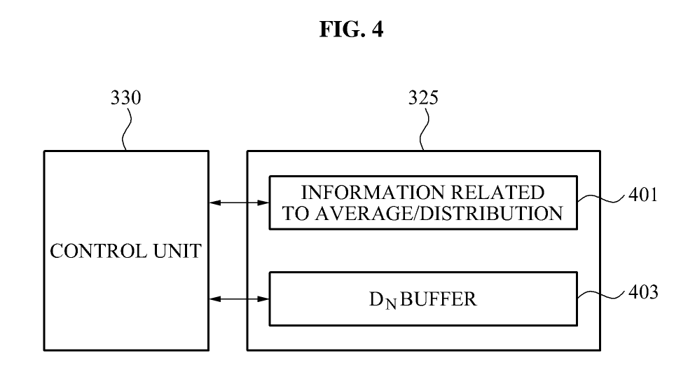

FIG. 4 is a view illustrating a configuration of the Mth memory area 325 of FIG. 3 according to an exemplary embodiment of the invention.

Referring to FIG. 4, the Mth memory area 325 may include an information area 401 related to average of the periodically measured MDT-related data or distribution of the periodically measured MDT-related data, and a DN buffer 403. The first memory area 321 and the second memory area 323 of FIG. 3 may have the same configuration as the Mth memory area 325.

The information area 401 may store an average of MDT-related data ‘DAverage’ and information about distribution of MDT-related data ‘DDistribution’.

The DN buffer 403 may store MDT-related data DN obtained from the measuring unit 310. In an example, the DN buffer 403 may maintain MDT-related data DN obtained at a current time TN and MDT-related data DN−1 obtained at time TN−1, time proceeding to the current time TN.

The control unit 330 may update a first ‘DAverage’ value by accounting for the newly obtained MDT-related data DN in the first ‘DAverage’ value stored in the information area 401. Accordingly, the first ‘DAverage’ value stored in the information area 401 may be modified to a second ‘DAverage’ value to reflect the newly obtained MDT-related data in its average. Also, the control unit 330 may update ‘DDistribution’ by reflecting newly obtained MDT-related data DN on the ‘DDistribution’ stored in the information area 401.

To update the ‘DAverage’ or the ‘DDistribution’ based on the MDT-related data DN, the information area 401 may maintain a look-up table, such as the table shown in Table 2. The numerical values provided in Table 2 represent the size of the data that may be used in the memory capacity of the user terminal.

TABLE 2
Cell No. (serving cell) 1, 2, . . . M

| Maximum | Minimum | Variation | Average | Count | Maximum | Minimum | Variation | Average | Count |
|---|---|---|---|---|---|---|---|---|---|
| Location information (latitude) | | | | | Received field strength (serving cell) | | | | |
| 10 Bits | 10 Bits | 15 Bits | 10 Bits | 5 Bits | 10 Bits | 10 Bits | 15 Bits | 10 Bits | 5 Bits |
| Location information (longitude) | | | | | Received field strength (neighbor cell 1) | | | | |
| 10 Bits | 10 Bits | 15 Bits | 10 Bits | 5 Bits | 10 Bits | 10 Bits | 15 Bits | 10 Bits | 5 Bits |
| Location information (altitude) | | | | | Received field strength (neighbor cell 2) | | | | |
| 10 Bits | 10 Bits | 15 Bits | 10 Bits | 5 Bits | 10 Bits | 10 Bits | 15 Bits | 10 Bits | 5 Bits |

Referring to Table 2, ‘count’ is the number of MDT-related data measured. That is, ‘count’ of 100 means that corresponding MDT-related data is measured 100 times. Accordingly, ‘count’ increases by ‘1’ if ‘DAverage’ or ‘DDistribution’ is updated.

‘Last data’ is the MDT-related data DN that is obtained most recently in a corresponding cell. Further, the ‘last data’ may be deleted from the memory unit 320 or may be maintained in the memory unit 320. If the ‘last data’ is set to be deleted, the control unit 330 may update at least one of ‘DAverage’ and ‘DDistribution’ and may delete the ‘last data’ from the memory unit 320. More specifically, the control unit 330 may update at least one of ‘DAverage’ and ‘DDistribution’ stored in the information area 401 and may delete the ‘last data’ stored in the DN buffer 403 of Mth memory area 325 located in the memory unit 320. Alternatively, the control unit 330 may update at least one of ‘DAverage’ and ‘DDistribution’ using the ‘last data’ without deleting the ‘last data’ from the memory unit 320.

If the memory configuration of FIG. 2 maintains a look-up table of Table 2, a comparison in a memory capacity between the example of FIG. 1 and the example of FIG. 2 may be made. This comparison is described more in detail below.

<Comparison in Memory Capacity Between an Example of FIG. 1 and an Example of FIG. 2>

In an example, MDT-related data DN measured in the MDT mode may be a received field strength. Also, a memory capacity of 10 bits may be used to record the received field strength. Furthermore, the received field strength may be assumed to be obtained in the same location every 2 seconds for 24 hours. In this instance, if the memory configuration of FIG. 1 is used, a memory capacity of 432,000 bits may be used as shown in Formula 1. Alternatively, if the memory configuration of FIG. 2 is used, a memory capacity of 60 bits may be used as shown in Formula 2. Thus, a capacity for storing MDT-related data may be reduced by using the memory configuration of FIG. 2, which may reduce a waste of communication resources used to report the MDT-related data to a network operator.

10×60(secs)×60(Minutes)×24(hours)/2(secs)=432,000 Formula 1

Last data (10 bits)+Maximum (10 bits)+Minimum (10 bits)+Average (10 bits)+Variation (15 bits)+Count (5 bits)=60 bits Formula 2

Accordingly, the memory configuration of FIG. 2 may store received field strength for 24 hours with a fraction of the memory capacity used to obtain raw data.

By storing data using the disclosed methods as illustrated in FIG. 2, the memory capacity for storing data related to MDT may be reduced while user terminal is in a MDT mode for obtaining the MDT-related data. Accordingly, the reduction in a storage capacity of MDT-related data may contribute to reducing of communication resources used in reporting MDT-related data to a network operator.

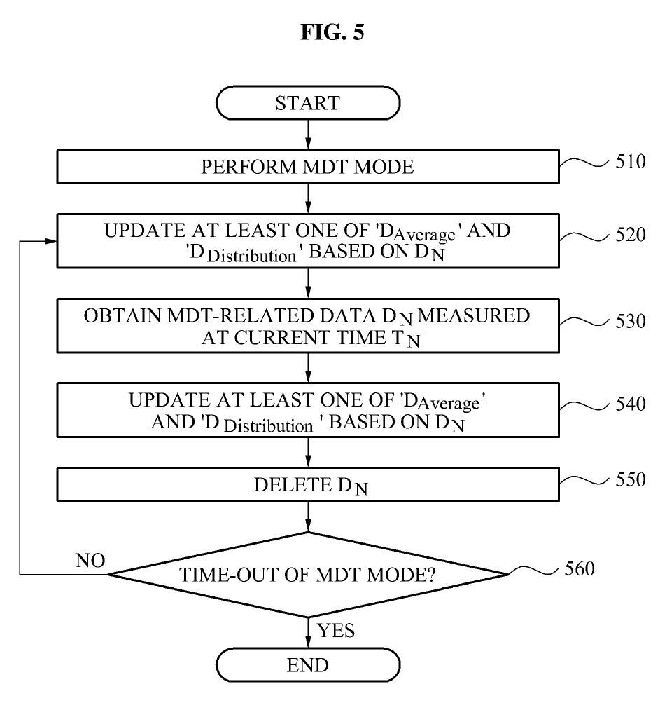

FIG. 5 is a flowchart illustrating a method for managing MDT-related data in a user terminal according to an exemplary embodiment of the invention.

The method of FIG. 5 may be performed by the user terminal 300 of FIG. 3.

Referring to FIG. 5, the user terminal 300 may entered into a MDT mode, in operation 510.

In operation 520, the user terminal 300 may maintain at least one of an average of periodically measured MDT-related data ‘DAverage’ and information about distribution of periodically measured MDT-related data ‘DDistribution’, based on a system parameter received from a base station. In an example, ‘based on a system parameter’ may describe ‘obtaining MDT-related data designated in the system parameter’. Alternatively, ‘based on a system parameter’ may describe ‘obtaining MDT-related data based on a measurement cycle designated in the system parameter’. Also, ‘based on a system parameter’ may describe ‘obtaining MDT-related data for a reference period of time designated in the system parameter’.

In operation 530, the user terminal 300 may obtain MDT-related data DN measured at a current time TN.

In operation 540, the user terminal 300 may update at least one of the ‘DAverage’ and the ‘DDistribution’ based on the DN.

If ‘last data’ as the MDT-related data DN that is obtained most recently in a corresponding cell is set to be deleted, the user terminal 300 may delete the ‘last data,’ in operation 550.

In operation 560, the user terminal 300 may check to determine whether the MDT mode has timed out. Information about time-out of the MDT mode may be included in the system parameter. That is, the user terminal 300 may operate a timer with reference to the system parameter if the user terminal 300 is in the MDT mode, and in operation 560, the user terminal 300 may check to determine whether the operation of the timer was terminated. Also, information about time-out of the MDT mode may be determined by a reference count value. That is, if the number of measurement of the MDT-related data exceeds a reference number, the user terminal 300 may determine that the MDT mode has timed out.

Alternatively, if the MDT mode did not time out, the user terminal 300 may repeat operation 520 to operation 550.

The method described with reference to FIG. 5 may be performed if the user terminal 300 is in a stationary state or stays in one cell for at least the reference period of time.

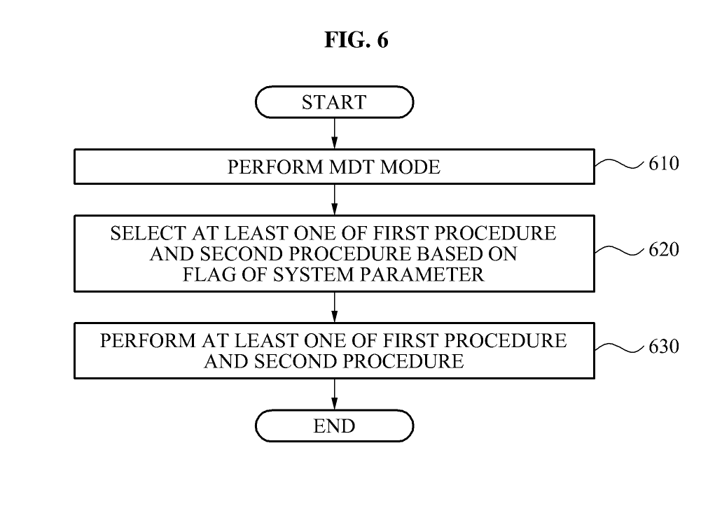

FIG. 6 is a flowchart illustrating a method for managing MDT-related data in a user terminal according to an exemplary embodiment of the invention.

The method described with reference to FIG. 6 may be performed by the user terminal 300 of FIG. 3.

Referring to FIG. 6, the user terminal 300 enters into a MDT mode, in operation 610.

In operation 620, the user terminal 300 selects at least one of a first procedure for storing periodically measured MDT-related data and a second procedure for processing and storing periodically measured MDT-related data, based on a flag of a system parameter received from a base station. The flag of the system parameter may vary depending on information about the MDT mode set by a network operator.

In operation 630, the user terminal 300 performs at least one of the first procedure and the second procedure. That is, the user terminal 300 may perform the first procedure or the second procedure based on the flag value of the system parameter. Also, the user terminal 300 may perform both the first procedure and the second procedure based on the flag value of the system parameter. The flag value of the system parameter may be set to perform the first procedure if the user terminal 300 continues to move, or may be set to perform the second procedure if the user terminal 300 is in a stationary state for a reference period of time or stays within a reference range.

The second procedure may include operation 520 to operation 540 of FIG. 5.

Hereinafter, a flag value of a system parameter that may be set by a network operator is described. For convenience, the network operator will be assumed to be a base station. However, network operator is not limited as such. The user terminal 300 may determine the MDT mode based on a system parameter received from a base station and a flag value included in the system parameter.

### <Setting of a Flag of a System Parameter>

A base station may set the MDT mode set in the user terminal 300 by designating a reference flag value to a system parameter.

For example, if a flag value is ‘0’, the user terminal 300 may not operate in the MDT mode or may terminate the MDT mode. Also, if a flag value is ‘1’, the user terminal 300 may perform a first procedure in the MDT mode. Also, if a flag value is ‘2’, the user terminal 300 may perform a second procedure in the MDT mode. Also, if a flag value is ‘3’, the user terminal 300 may perform both a first procedure and a second procedure. In this instance, the user terminal 300 may maintain both the memory configuration of FIG. 1 and the memory configuration of FIG. 2.

The flag value set by the base station may be set in various manners.

For example, the flag value may be designated based on mobility of the user terminal 300. That is, the flag of the system parameter may be set to perform a first procedure if location information or a serving cell of the user terminal 300 changes. Alternatively, the flag of the system parameter may be set to perform a second procedure if there is no change in location information of the user terminal 300 for a reference period of time, or if the user terminal 300 stays in a serving cell for a reference period of time. Because the base station may recognize location information of the user terminal 300 in real time, the base station may sense mobility of the user terminal 300. Alternatively, the base station may sense mobility of the user terminal 300 by recognizing the location information of the user terminal 300 at time intervals. Also, the flag value may be set based on a period of time during which the user terminal 300 stays in a reference location. That is, if a period of time during which the user terminal 300 stays in the reference location is equal to or greater than a reference time, the base station may set the flag value to execute a second procedure.

Although not shown in FIGS. 5 and 6, if the user terminal 300 receives a new system parameter from the base station during the MDT mode, the user terminal 300 may change the MDT mode based on the new system parameter. Accordingly, if the user terminal 300 in stationary state moves to a boundary area between cells, the base station may change a flag value to ‘1’ and transmit the changed flag value to the user terminal 300. In this instance, the user terminal 300 may stop performing a second procedure and may proceed to perform a first procedure, in accordance to the flag value included in the new system parameter.

Also, if a ‘radio link failure’ occurs between the user terminal and the base station during the second procedure, the flag of the system parameter may be set to perform a first procedure. That is, if a radio link failure occurs in an uplink or downlink, the flag of the system parameter may be set to stop performing the second procedure and to perform a first procedure. Alternatively, the flag of the system parameter may be set to terminate the second procedure and to perform the first procedure if there is a connectivity failure while performing the second procedure. In addition, the flag of the system parameter may be set to retry the second procedure for a reference number of tries or reference duration before performing the first procedure if connectivity failure occurs while performing the second procedure.

Also, the flag of the system parameter may include group information, and the group information may be sorted into a first group set to perform a first procedure, a second group set to perform a second procedure, and a third group set to perform both the first procedure and the second procedure. That is, a base station may group user terminals in a cell and may variably designate a MDT mode for each group.

Also, the flag of the system parameter may include information about a received field strength range related to the first procedure and the second procedure. In this instance, the received field strength range may be sorted into a first range for performing the first procedure and a second range for performing the second procedure. For example, if a field strength of a signal received from the user terminal 300 is between −60 dBm and −90 dBm, the base station may set a flag value to perform a second procedure, and if the field strength of the signal received from the user terminal 300 is equal or larger than −60 dBm, the base station may set a flag value to perform the first procedure. Similarly, if the field strength of the signal received from the user terminal 300 is equal or less than −90 dBm, the base station may set a flag value to execute the first procedure.

In addition, a system parameter and a flag value included in the system parameter may be changed. Also, the system parameter and the flag value included in the system parameter may be maintained until a base station transmits the changed information to the user terminal 300. Accordingly, the system parameter may be set for the user terminal 300 to operate in the MDT mode by a reference procedure. In this instance, the system parameter may include at least one of information about a measurement cycle of MDT-related data, information about a storage architecture of MDT-related data, information about a type of MDT-related data, a reporting time of MDT-related data, and information about the MDT mode.

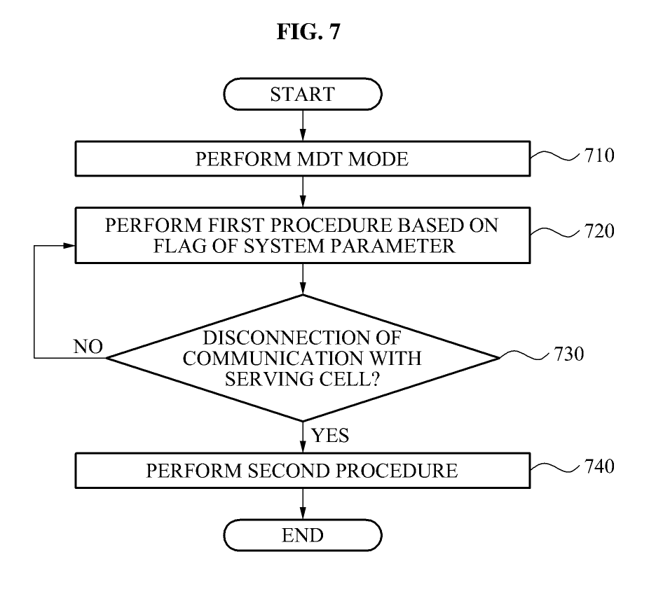

FIG. 7 is a flowchart illustrating a method for managing MDT-related data according to an exemplary embodiment of invention.

For convenience, FIG. 7 will be described as if the method was performed by the user terminal 300 of FIG. 3. However, the method is not limited as such.

Referring to FIG. 7, the user terminal 300 enters into a MDT mode, in operation 710.

In operation 720, the user terminal 300 performs a first procedure for storing periodically measured MDT-related data, based on a flag of a system parameter received from a base station. In this instance, if a reference condition occurs, the flag of the system parameter may be a value set to terminate the first procedure and perform a second procedure. In the example of FIG. 7, the reference condition may be ‘occurrence of disconnection of communication with a serving cell,’ which may be a loss of connectivity with the serving cell.

In operation 730, the user terminal 300 checks whether disconnection of communication with a serving cell has occurred.

In operation 740, the user terminal 300 may perform the second procedure for location information of the user terminal 300 if disconnection of communication with a serving cell is determined to have occurred. That is, the user terminal 300 may stop measuring received field strength of the user terminal 300 among MDT-related data, and may measure location information of the user terminal 300 among MDT-related data, in operation 740.

If a disconnection of communication with the serving cell occurs, the user terminal 300 may not measure received field strength of the user terminal 300. In this instance, information most useful to a network operator may be the identification of a non-service area. Accordingly, if disconnection of communication with a serving cell is determined to have occurred, the user terminal 300 may periodically obtain location information by activating a location measuring apparatus such as a global positioning system (GPS) receiver (not shown), and may store average accumulated distribution data for the obtained location information data in a memory.

The second procedure for measuring location information of the user terminal 300 may include a series of steps. In an example, a process for measuring location information of the user terminal 300 may include the following steps:

a) maintaining at least one of an average of the periodically measured location information of the user terminal ‘L_{Average}’ and information about distribution of the periodically measured location information of the user terminal ‘L_{Distribution}’,

b) obtaining location information of the user terminal L_{N} measured at a current time T_{N}, and

c) updating at least one of the ‘L_{Average}’ and the ‘L_{Distribution}’ based on the L_{N}.

The average of the location information ‘L_{Avergae}’ may include an average of periodically measured latitude, an average of periodically measured longitude, and an average of periodically measured altitude. Also, the ‘L_{Distribution}’ may include a maximum, a minimum, a variation, and a standard deviation of each of latitude, longitude, and altitude.

If the user terminal 300 becomes capable of communicating with the serving cell, the user terminal 300 may transmit at least one of the ‘L_{Average}’ and the ‘L_{Distribution}’ to the network operator. In this instance, assuming the network operation is a base station for ease of description, the base station may determine which area is a non-service area using the ‘L_{Average}’ or the ‘L_{Distribution}’.

The disclosure can also be embodied as computer readable codes on a computer readable recording medium. The computer readable recording medium may be any data storage device that can store data which can be thereafter read by a computer system.

Examples of the computer readable recording medium may include read-only memory (ROM), random-access memory (RAM), CD-ROMs, magnetic tapes, floppy disks, optical data storage devices, and carrier waves such as data transmission through the Internet. The computer readable recording medium can also be distributed over network coupled computer systems so that the computer readable code is stored and executed in a distributed fashion.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method for managing data related to minimization of drive-tests (MDT) in a user terminal, the method comprising:
entering into a MDT mode;
receiving a system parameter from a base station;
obtaining MDT-related data D_{N} measured at a current time T_{N}; and
updating at least one of an average of the periodically measured MDT-related data ‘D_{Average}’ and information about distribution of the periodically measured MDT-related data ‘D_{Distribution}’ to reflect the MDT-related data D_{N} based on the system parameter.

2. The method of claim 1, further comprising:
updating at least one of the ‘D_{Average}’ and the ‘D_{Distribution}’ and deleting the D_{N}.

3. The method of claim 1, wherein the system parameter comprises at least one of information about a measurement cycle of the MDT-related data D_{N}, information about a storage architecture of the MDT-related data D_{N}, information about a type of the MDT-related data D_{N}, a reporting time of the MDT-related data D_{N}, and information about the MDT mode of the user terminal.

4. The method of claim 1, wherein ‘D_{Average}’ and ‘D_{Distribution}’ for each cell are separately maintained in a memory, if the user terminal moves to a plurality of cells while the mobile terminal is in the MDT mode.

5. The method of claim 1, wherein the MDT-related data D_{N} comprises at least one of location information of the user terminal, and information about a received field strength of the user terminal.

6. The method of claim 1, wherein the information about distribution of the MDT-related data ‘D_{Distribution}’ comprises at least one of a maximum, a minimum, a variation, a standard deviation, and the number of the periodically measured MDT-related data.

7. A method for managing data related to minimization of drive-tests (MDT) in a user terminal, the method comprising:
entering into a MDT mode;
receiving a system parameter comprising a flag from a base station;
selecting at least one of a first procedure for storing periodically measured MDT-related data, and a second procedure for processing and storing the periodically measured MDT-related data, based on the flag of a system parameter; and
performing at least one of the first procedure and the second procedure.

8. The method of claim 7, wherein the second procedure comprises:
storing at least one of an average of the periodically measured MDT-related data ‘D_{Average}’ and information about distribution of the periodically measured MDT-related data ‘D_{Distribution}’;
obtaining MDT-related data D_{N} measured at a current time T_{N}; and
updating at least one of the ‘D_{Average}’ and the ‘D_{Distribution}’ based on the MDT-related data D_{N}.

9. The method of claim 7, wherein the flag of the system parameter is set to perform the first procedure if location information of a serving cell of the user terminal changes, and is set to perform the second procedure if there is no change in the location information of the user terminal for a reference period of time or if the user terminal stays in the serving cell for a reference period of time.

10. The method of claim 7, wherein the flag of the system parameter is set to perform the first procedure if a connection failure occurs between the user terminal and the base station while performing the second procedure.

11. The method of claim 7, wherein the flag of the system parameter comprises group information,
wherein the group information is sorted into a first group set to perform the first procedure, a second group set to perform the second procedure, and a third group set to perform both the first procedure and the second procedure.

12. The method of claim 7, wherein the flag of the system parameter comprises information about a received field strength range related to the first procedure and the second procedure,
wherein the received field strength range is sorted into a first range for performing the first procedure and a second range for performing the second procedure.

13. A method for managing data related to minimization of drive-tests (MDT) in a user terminal, the method comprising:
entering into a MDT mode;
determining whether disconnection of communication with a serving cell occurred; and
stopping measuring of a received field strength of the user terminal and measuring location information of the user terminal among the MDT-related data, if disconnection of communication with a serving cell occurred.

14. The method of claim 13, wherein the measuring of the location information of the user terminal comprises:
storing at least one of an average of the periodically measured location information of the user terminal ‘L_{Average}’ and information about distribution of the periodically measured location information of the user terminal ‘L_{Distribution}’;
obtaining location information L_{N} of the user terminal measured at a current time T_{N}; and
updating at least one of the ‘L_{Average}’ and the ‘L_{Distribution}’ based on the L_{N}.

15. A user terminal, comprising:
a measuring unit to measure data related to minimization of drive-tests (MDT) in a MDT mode;
a memory unit to store at least one of an average of the periodically measured MDT-related data ‘D_{Average}’ and information about distribution of the periodically measured MDT-related data ‘D_{Distribution}’, based on a system parameter received from a base station; and
a control unit to update at least one of the ‘D_{Average}’ and the ‘D_{Distribution}’ based on MDT-related data D_{N} measured at a current time T_{N}.

16. The user terminal of claim 15, wherein the control unit updates at least one of the ‘D_{Average}’ and the ‘D_{Distribution}’ and deletes the MDT-related data D_{N} from the memory unit.

17. The user terminal of claim 15, wherein the control unit separately stores ‘D_{Average}’ and ‘D_{Distribution}’ for each cell in the memory unit, if the user terminal moves to a plurality of cells during the MDT mode.

18. The user terminal of claim 15, wherein the system parameter comprises at least one of information about a measurement cycle of the MDT-related data D_{N}, information about a storage architecture of the MDT-related data D_{N}, information about a type of the MDT-related data D_{N}, a reporting time of the MDT-related data D_{N}, and information about the MDT mode.

19. The user terminal of claim 15, wherein the MDT-related data D_{N} comprises at least one of location information of the user terminal and information about a received field strength of the user terminal.

20. The user terminal of claim 15, wherein the information about distribution of the MDT-related data ‘D_{Distribution}’ comprises at least one of a maximum, a minimum, a variation, a standard deviation, and the number of the periodically measured MDT-related data D_{N}.

21. The user terminal of claim 15, wherein the control unit controls a MDT mode based on a flag of the system parameter received from the base station and a determination of whether disconnection of communication with a serving cell has occurred.

22. The user terminal of claim 21, wherein the MDT mode comprises a first procedure for storing periodically measured MDT-related data D_{N}, and a second procedure for maintaining at least one of an average of the periodically measured MDT-related data ‘D_{Average}’ and information about distribution of the periodically measured MDT-related data ‘D_{Distribution}’.
